(19) United States
(12) Patent Application Publication
(10) Pub. No.: US 2026/0297326 A1
(43) Pub. Date: Oct. 1, 2026

(54) POLYAMIDE COMPOSITION AND POLAR GRAPHENE

(71) Applicant: ARKEMA FRANCE, Puteaux (FR)

(72) Inventors: Thomas PRENVEILLE, Serquigny (FR); Claude-Olivier BOISSIERE, Serquigny (FR); Marjorie MARCOURT, Serquigny (FR); Bertrand VERBAUWHEDE, Serquigny (FR)

(73) Assignee: ARKEMA FRANCE, Puteaux (FR)

(21) Appl. No.: 19/490,187

(22) PCT Filed: Jun. 6, 2024
(86) PCT No.: PCT/FR2024/050726

§ 371 Date: Dec. 4, 2025

(30) Foreign Application Priority Data
Jun. 6, 2023 (FR) FR2305679

(51) Int. Cl. C08L 77/02; B29C 48/00; B29C 48/09; B29C 49/00; B29L 23/00; B29L 31/00; C08K 3/04; C08K 5/00; C08L 77/06

(52) U.S. Cl. CPC C08L 77/02; B29C 48/022; B29C 48/09; C08K 3/042; C08K 5/005; C08L 77/06; B29C 49/0005; B29L 2023/22; B29L 2031/7172; C08L 2203/18

(57) ABSTRACT

The invention relates to a composition comprising, relative to the total weight of the composition:
at least 50% by weight of at least one polyamide with an inherent viscosity of greater than 1.2;
from 0.05% to 20% by weight of a polar graphene with a mean thickness of between 0.5 and 75 nm;
from 3% to 40% by weight of at least one impact modifier.

The invention also relates to the use of this composition for the preparation of a single-layer or multilayer structure for storing, transporting, and distributing fluid, notably transport vehicle fluid.

### FIELD OF THE INVENTION

The present invention relates to polyamide and graphene compositions for manufacturing single-layer or multilayer structures, notably for fluid transport, distribution or storage applications.

### TECHNICAL BACKGROUND

The supply of fluids to transport vehicles, for example motor vehicles, trains, trucks, etc., notably the supply of fuel for internal combustion vehicles, the supply of coolant fluid, the supply of hydrogen to fuel cells, etc., requires the presence of storage, distribution and transport structures such as tanks, pipes, etc.

These structures must fulfil two essential functions:
leaktightness or low permeability, so as to limit fluid losses;
mechanical strength (tensile strength and impact strength).

Moreover, it is essential for the fluid to convey little or no contaminants from storage, distribution or transport structures. Thus, it is essential that the compositions forming said storage, distribution or transport structures have the lowest possible extractable matter content.

There is thus a real need to provide compositions allowing the preparation of structures for storing, distributing and/or transporting fluids, notably fluids used in transport vehicles, having, in addition to good mechanical strength properties:
low permeability, so as to limit fluid losses; and/or
a low extractable matter content.

There is also a need to provide such compositions for preparing fluid storage, distribution and/or transport structures which, in addition, have:
good fire resistance, notably the structure is fire-resistant with a V0, V1 or V2 result on the UL94 test (IEC 60695-11-10); and/or
good thermal and/or electrical conductivity; and/or
a good compromise between low density and good mechanical strength.

### SUMMARY OF THE INVENTION

The invention relates firstly to a composition comprising, relative to the total weight of the composition:
at least 50% by weight of at least one polyamide with an inherent viscosity of greater than 1.2;
from 0.05% to 20% by weight of a polar graphene;
from 3% to 40% by weight of at least one impact modifier.

Particularly preferably, the present invention relates to a composition comprising, relative to the total weight of the composition:
at least 50% by weight of at least one polyamide with an inherent viscosity of greater than 1.2;
from 0.05% to 20% by weight of a polar graphene with a mean thickness of between 0.5 and 75 nm;
from 3% to 40% by weight of at least one impact modifier.

In one embodiment, the polar graphene is a graphene oxide or a graphene functionalized with at least one polyamide-reactive function, preferably a function chosen from maleic anhydrides, carboxylic acids, primary amines and isocyanates, preferably maleic anhydrides and amines.

In one embodiment, the polyamide of the composition according to the invention is:
an aliphatic polyamide derived from the polycondensation of:
   at least one C6 to C18, preferentially C9 to C18, more preferentially C10 to C18, even more preferentially C10 to C12 and notably C11 amino acid; or
   at least one C6 to C18, preferentially C9 to C18, more preferentially C10 to C18, even more preferentially C10 to C12 and notably C12 lactam; or
   at least one C4-C36, notably C6-C36, preferentially C6-C18, preferentially C6-C12 and more preferentially C10-C12 aliphatic diamine Ca with at least one C4-C36, notably C6-C36, preferentially C6-C18, preferentially C10-C18 and more preferentially C10-C12 aliphatic diacid Cb; or
a semiaromatic polyamide of formula A/XT in which A is chosen from a unit obtained from an amino acid, a unit obtained from a lactam and a unit corresponding to the formula (Cc diamine). (Cd diacid), with c representing the number of carbon atoms of the diamine and d representing the number of carbon atoms of the diacid, c and d each being of between 4 and 36, advantageously between 9 and 18, the (Cc diamine) unit being chosen from linear or branched aliphatic diamines as defined above, cycloaliphatic diamines and alkylaromatic diamines and the (Cd diacid) unit being chosen from linear or branched aliphatic diacids, cycloaliphatic diacids and aromatic diacids; X·T denotes a unit obtained from the polycondensation of a Cx diamine and of terephthalic acid, with x representing the number of carbon atoms of the Cx diamine, x being between 5 and 36, advantageously between 9 and 18, and T corresponds to terephthalic acid.

Preferably, the polyamide is:
an aliphatic polyamide chosen from PA6, PA66, PA11, PA12, PA610, PA612, PA1010, PA1012 and PA1212;
a semiaromatic polyamide chosen from PA MPMDT/6T, PA11/10T, PA 5T/10T, PA 11/BACT, PA 11/6T/10T, PA MXDT/10T, PA MPMDT/10T, PA BACT/10T, PA BACT/6T, PA BACT/10T/6T, PA 11/BACT/6T, PA 11/MPMDT/6T, PA 11/MPMDT/10T, PA 11/BACT/10T, PA 11/MXDT/10T and 11/5T/10T, T corresponds to terephthalic acid, MXD corresponds to m-xylylenediamine, MPMD corresponds to methylpentamethylenediamine and BAC corresponds to bis(aminomethyl)cyclohexane.

According to one embodiment, the composition preferably comprises, relative to the total weight of polyamide, more than 50% by weight, preferably more than 70% by weight and more preferentially more than 85% by weight of aliphatic polyamide. Preferably, the composition according to the invention comprises, by weight relative to the total weight of polyamide, 100% by weight of aliphatic polyamide.

In one embodiment, the impact modifier is chosen from olefin copolymers and notably copolymers comprising ethylene or propylene units.

The present invention also relates to single-layer or multilayer structures in which the layer in the case of the single-layer structure or at least one of the layers in the case of the multilayer structure is formed totally or partly from the composition according to the invention.

In one embodiment, these structures are tubular structures.

In another embodiment, these structures are tanks.

The present invention also relates to the use of said structures for transporting, distributing and storing a fluid.

In one embodiment, the fluid is hydrogen.

In another embodiment, the fluid is a fuel.

The present invention also relates to the use of a composition according to the invention for the manufacture of a single-layer or multilayer structure by injection, extrusion, extrusion-blow molding or rotational molding, preferably by extrusion.

The present invention also relates to the use of from 0.05% to 20% by weight of at least one polar graphene with an average thickness of between 0.5 and 75 nm in a composition comprising at least 50% by weight of at least one polyamide with an inherent viscosity of greater than 1.2, optionally up to 5% by weight of at least one additive, optionally up to 40% by weight of at least one impact modifier and/or optionally up to 1% by weight of at least one plasticizer, the percentages being given relative to the total weight of the composition, to obtain an extractable matter content of less than or equal to 4 g/m², preferably less than or equal to 3 g/m².

The present invention also relates to the use of from 0.05% to 20% by weight of at least one polar graphene with an average thickness of between 0.5 and 75 nm in a composition comprising at least 50% by weight of at least one polyamide with an inherent viscosity of greater than 1.2, optionally up to 5% by weight of at least one additive, optionally up to 40% by weight of at least one impact modifier and/or optionally up to 1% by weight of at least one plasticizer, the percentages being given relative to the total weight of the composition, to obtain an extractable matter content lower than that obtained for the same graphene-free composition in which graphene has been replaced with the same amount of polyamide.

The present invention also relates to the use of from 0.05% to 20% by weight of at least one polar graphene with an average thickness of between 0.5 and 75 nm in a composition comprising at least 50% by weight of at least one polyamide with an inherent viscosity of greater than 1.2, optionally up to 5% by weight of at least one additive, optionally up to 40% by weight of at least one impact modifier and/or optionally up to 1% by weight of at least one plasticizer, the percentages being given relative to the total weight of the composition, to obtain a permeability lower than that obtained for the same graphene-free composition in which graphene has been replaced with the same amount of polyamide.

The present invention also relates to a process for manufacturing a single-layer or multilayer structure, characterized in that it comprises a step of manufacturing a sealing layer by injection, extrusion, extrusion-blow molding or rotational molding.

In a particularly advantageous manner, the inventors have shown that the combination of polyamide with graphene notably allows the mechanical strength to be improved while at the same time limiting the density of the fluid storage, distribution and/or transport structures prepared from these compositions.

Particularly advantageously, the composition according to the invention affords a hydrogen permeability, measured in accordance with the standard ISO 15105-2 at atmospheric pressure and 60° C., of less than 10.00×10⁻¹⁶ mol·m/m²·s·Pa, preferably less than 9.50×10⁻¹⁶ mol·m/m²·s·Pa.

In addition to this feature, the composition according to the invention preferably affords at least one of the following properties:
an extractable matter content, measured according to the standard TL52712, of less than or equal to 4 g/m², preferably less than 3 g/m²;
a thermal conductivity, measured according to the standard ASTMD5930-17, of greater than 0.5 W/m·K, preferably greater than 0.6 W/m·K;
a surface resistivity, measured according to the standard IEC62631-3-2 (2015), of less than 10⁶ Ω·m, preferably less than 104 Ω·m;
a tensile modulus measured according to the standard ISO527, after conditioning for 15 days at 23° C. and 50% relative humidity, of between 100 and 3000 MPa, preferably between 800 and 2000 MPa;
an elongation at break measured according to the standard ISO527, after conditioning for 15 days at 23° C. and 50% relative humidity, of greater than 10%, preferably greater than 20%, notably greater than 100%;
an impact strength at 23° C., measured according to the standard ISO1791eA, of greater than 5 kJ/m², preferably greater than 8 kJ/m².

### DETAILED DESCRIPTION

The invention is now described in greater detail and in a nonlimiting manner in the description which follows.

Unless otherwise indicated, all the percentages are mass percentages.

In the present text, the amounts indicated for a given species may apply to that species according to all its definitions (as mentioned in the present text), including the more restricted definitions.

The present invention relates to a composition comprising, relative to the total weight of the composition:
at least 50% by weight of at least one polyamide with an inherent viscosity of greater than 1.2;
from 0.05% to 20% by weight of a polar graphene;
from 3% to 40% by weight of at least one impact modifier.

Preferably, the present invention relates to a composition comprising, relative to the total weight of the composition:
at least 50% by weight of at least one polyamide with an inherent viscosity of greater than 1.2;
from 0.05% to 20% by weight of a polar graphene with a mean thickness of between 0.5 and 75 nm;
from 3% to 40% by weight of at least one impact modifier.

The present invention also relates to the use of from 0.05% to 20% by weight of at least one polar graphene in a composition comprising, relative to the total weight of the composition, at least 50% by weight of at least one polyamide with an inherent viscosity of greater than 1.2, optionally up to 5% by weight of at least one additive, optionally up to 40% by weight of at least one impact modifier and/or optionally up to 14% by weight of at least one plasticizer; to obtain an extractable matter content less than or equal to 4 g/m², preferably less than 3 g/m² according to the standard TL52712.

Preferably, the present invention also relates to the use of from 0.05% to 20% by weight of at least one polar graphene with an average thickness of between 0.5 and 75 nm, in a composition comprising, relative to the total weight of the composition, at least 50% by weight of at least one polyamide with an inherent viscosity of greater than 1.2, optionally up to 5% by weight of at least one additive, optionally up to 40% by weight of at least one impact modifier and/or optionally up to 14% by weight of at least one plasticizer; to obtain an extractable matter content less than or equal to 4 g/m², preferably less than 3 g/m² according to the standard TL52712.

The present invention also relates to the use of from 0.05% to 20% by weight of at least one polar graphene in a composition comprising, relative to the total weight of the composition, at least 50% by weight of at least one polyamide with an inherent viscosity of greater than 1.2, optionally up to 5% by weight of at least one additive, optionally up to 40% by weight of at least one impact modifier and/or optionally up to 14% by weight of at least one plasticizer; to obtain an extractable matter content lower than that obtained for the same graphene-free composition, in which the graphene has been replaced with the same amount of polyamide in the composition.

Preferably, the present invention relates to the use of from 0.05% to 20% by weight of at least one polar graphene with an average thickness of between 0.5 and 75 nm, in a composition comprising, relative to the total weight of the composition, at least 50% by weight of at least one polyamide with an inherent viscosity of greater than 1.2, optionally up to 5% by weight of at least one additive, optionally up to 40% by weight of at least one impact modifier and/or optionally up to 14% by weight of at least one plasticizer; to obtain an extractable matter content lower than that obtained for the same graphene-free composition, in which the graphene has been replaced with the same amount of polyamide in the composition.

The present invention also relates to the use of from 0.05% to 20% by weight of at least one polar graphene in a composition comprising, relative to the total weight of the composition, at least 50% by weight of at least one polyamide with an inherent viscosity greater than 1.2, optionally up to 5% by weight of at least one additive, optionally up to 40% by weight of at least one impact modifier and/or optionally up to 14% by weight of at least one plasticizer, to obtain a fluid permeability lower than that obtained for the same graphene-free composition, in which the graphene has been replaced with the same amount of polyamide in the composition.

The present invention preferably relates to the use of from 0.05% to 20% by weight of at least one polar graphene with an average thickness of between 0.5 and 75 nm, in a composition comprising, relative to the total weight of the composition, at least 50% by weight of at least one polyamide with an inherent viscosity of greater than 1.2, optionally up to 5% by weight of at least one additive, optionally up to 40% by weight of at least one impact modifier and/or optionally up to 14% by weight of at least one plasticizer, to obtain a fluid permeability lower than that obtained for the same graphene-free composition, in which the graphene has been replaced with the same amount of polyamide in the composition.

### Composition

### Polyamide

The composition according to the invention comprises at least 50% by weight, preferably from 70% to 99.5% by weight and more preferably from 90% to 99% by weight of at least one polyamide.

The nomenclature used to define polyamides is described in the standard ISO 1874-1:2011 “Plastics—Polyamide (PA) molding and extrusion materials—Part 1: Designation”, in particular on page 3 (Tables 1 and 2), and is well known to a person skilled in the art.

The polyamide has an inherent viscosity of greater than 1.2, preferably greater than 1.3, more preferentially greater than 1.4 and even more preferably greater than 1.6.

Measurement of the inherent (or intrinsic) viscosity is performed in m-cresol. The method is well known to those skilled in the art. The standard ISO 307:2007 is followed, but changing the solvent (use of m-cresol instead of sulfuric acid), the temperature (being 20° C.) and the concentration (being 0.5% by mass).

The polyamide of the invention is advantageously a polyamide that is compatible with use by injection or extrusion, preferably extrusion.

The polyamide may be a homopolyamide or a copolyamide or a mixture thereof.

The polyamide is a semicrystalline polyamide, i.e. a material which is generally solid at room temperature and which softens during a temperature increase, in particular after passing its glass transition temperature (Tg), and which can melt sharply when passing its so-called melting temperature (Tm), and which becomes solid again when the temperature falls below its crystallization temperature.

The Tg, the Tc (crystallization temperature) and the Tm are determined by differential scanning calorimetry (DSC) according to the standards 11357-2:2013 and 11357-3:2013, respectively.

The number-average molecular mass Mn of said semicrystalline polyamide is preferably in a range extending from 10 000 to 85 000 g/mol, notably from 10 000 to 60 000 g/mol, preferentially from 10 000 to 50 000 g/mol, even more preferentially from 12 000 to 50 000 g/mol. The number-average molecular mass Mn can be measured by any method known to those skilled in the art, and in particular the number-average molar mass (Mn) and weight-average molar mass (Mw) are determined by size exclusion chromatography in accordance with standards ISO 16014-1:2012, 16014-2:2012 and 16014-3:2012, under the following conditions:
Apparatus: Waters Alliance 2695 instrument
Solvent: hexafluoroisopropanol stabilized with 0.05 M potassium trifluoroacetate
Flow rate: 1 ml/minute
Column temperature: 40° C.
Two columns in series: 1000 Å PFG and 100 Å PFG (PPS)
Sample concentration: 1 g/l (dissolution at ambient temperature for 24 h)
Filtration of samples using a syringe fitted with an Acrodisc PTFE filter of 25 mm diameter and 0.2 μm porosity
Injection volume: 100 μl
Refractometric detection at 40° C. with UV detection at 228 nm
Calibration by PMMA standards from 1 900 000 to 402 g·mol⁻¹. Calibration curve modeled by a fifth degree polynomial.

In one embodiment, the polyamide is chosen from an aliphatic polyamide, a semiaromatic polyamide and a mixture of the two, advantageously an aliphatic polyamide.

Said aliphatic polyamide may be derived from the polycondensation of:
at least one C6 to C18, preferentially C9 to C18, more preferentially C10 to C18, even more preferentially C10 to C12 and notably C11 amino acid; or
at least one C6 to C18, preferentially C9 to C18, more preferentially C10 to C18, even more preferentially C10 to C12 and notably C12 lactam; or
at least one C4-C36, notably C6-C36, preferentially C6-C18, preferentially C6-C12 and more preferentially C10-C12 aliphatic diamine Ca with at least one C4-C36, notably C6-C36, preferentially C6-C18, preferentially C10-C18 and more preferentially C10-C12 aliphatic diacid Cb.

A C6 to C12 amino acid is notably 6-aminohexanoic acid, 9-aminononanoic acid, 10-aminodecanoic acid, 10-aminoundecanoic acid, 12-aminododecanoic acid and 11-aminoundecanoic acid and also derivatives thereof, notably N-heptyl-11-aminoundecanoic acid.

When said at least one semicrystalline aliphatic polyamide is obtained from the polycondensation of at least one amino acid, it can thus comprise a single amino acid or several amino acids.

Advantageously, said semicrystalline aliphatic polyamide is obtained from the polycondensation of a single amino acid and said amino acid is chosen from 11-aminoundecanoic acid and 12-aminododecanoic acid, advantageously 11-aminoundecanoic acid.

The C6 to C12 lactam is notably caprolactam, decanolactam, undecanolactam or lauryllactam.

When said at least one semicrystalline aliphatic polyamide is obtained from the polycondensation of at least one lactam, it may therefore comprise a single lactam or several lactams.

Advantageously, said at least one semicrystalline aliphatic polyamide is obtained from the polycondensation of a single lactam and said lactam is chosen from lauryllactam and undecanolactam, advantageously lauryllactam.

The Ca diamine may be linear or branched. Advantageously, it is linear.

Said at least one C4-C36 diamine Ca may be chosen in particular from butanemethylenediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one Ca diamine is a C6-C36 diamine and is chosen from 1,6-hexamethylenediamine, 1,7-heptamethylenediamine, 1,8-octamethylenediamine, 1,9-nonamethylenediamine, 1,10-decamethylenediamine, 2,2,4-trimethylhexanediamine (TMD), 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Said at least one Cb C4-C36 dicarboxylic acid may be chosen from butanedioic acid, pentanedioic acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Preferably, the polyamide according to the invention has a C/N ratio greater than 6.5, preferentially greater than 8, advantageously greater than 9.

Advantageously, the aliphatic polyamide is chosen from PA6, PA66, PA11, PA12, PA610, PA612, PA1010, PA1012 and PA1212, preferably PA11, PA12, PA610, PA612, PA1010, PA1012 and PA1212, preferably PA11, PA610, PA1010, PA1012 and PA1212, preferably PA11 and PA12, preferably PA11.

Said semiaromatic polyamide may notably be a semiaromatic polyamide of formula X/YAr, as described in EP1505099, notably a semiaromatic polyamide of formula A/XT in which A is chosen from a unit obtained from an amino acid as defined above, a unit obtained from a lactam as defined above and a unit corresponding to the formula (Cc diamine). (Cd-diacid), with c representing the number of carbon atoms of the diamine and d representing the number of carbon atoms of the diacid, c and d each being between 4 and 36, advantageously between 9 and 18, the (Cc-diamine) unit being chosen from linear or branched aliphatic diamines, as defined above, cycloaliphatic diamines and alkylaromatic diamines, and the (Cd-diacid) unit being chosen from linear or branched aliphatic diacids as defined above, cycloaliphatic diacids and aromatic diacids;

X·T denotes a unit obtained from the polycondensation of a Cx diamine and terephthalic acid, with x representing the number of carbon atoms of the Cx diamine, x being between 5 and 36, advantageously between 9 and 18, notably a polyamide of formula A/5T, A/6T, A/9T, A/10T or A/11T, A being as defined above, in particular a polyamide chosen from a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/6T, a PA 11/MPMDT/10T, a PA 11/BACT/10T, a PA 11/MXDT/10T or a PA 11/5T/10T.

T corresponds to terephthalic acid, MXD corresponds to m-xylylenediamine, MPMD corresponds to methylpentamethylenediamine and BAC corresponds to bis(aminomethyl)cyclohexane.

Said semiaromatic polyamide may also be a polyamide of formula ZAr in which Z is a unit derived from the polycondensation of at least one Ca aliphatic diamine as defined above and Ar is an aromatic dicarboxylic acid, in particular terephthalic acid, isophthalic acid and naphthalenic acid.

In one embodiment, the polyamide is aliphatic and chosen from PA6, PA66, PA11, PA12, PA610, PA612, PA1010, PA1012 and PA1212.

In another embodiment, the polyamide is semiaromatic and chosen from polyamide 11/5T, 11/6T, 11/10T, MXDT/10T, MPMDT/10T and BACT/10T.

Preferably, the semiaromatic polyamide content is less than 30% by weight relative to the total weight of polyamide in the composition according to the invention.

In one embodiment, said polyamide of said composition is prewashed at least once with a system chosen from a polar solvent, in particular methanol, water or steam, or a mixture thereof.

According to a preferred embodiment, the composition comprises, relative to the total weight of polyamide, more than 50% by weight, preferably more than 70% by weight and more preferentially more than 85% by weight of aliphatic polyamide. Preferably, the composition according to the invention comprises, by weight relative to the total weight of polyamide, 100% by weight of aliphatic polyamide.

### Polar Graphene

The composition of the invention comprises from 0.05% to 20% by weight, preferably from 0.1% to 15% by weight, more preferentially from 0.1% to 5% by weight, even more preferably from 0.1% to 2% by weight, preferably from 0.1% to 1.75% by weight, more preferentially from 0.1% to 1.5% by weight, more preferentially from 0.1% to 1% by weight, and even more preferably between 0.1% and 0.75% by weight of at least one polar graphene.

In the case of analysis of the graphene included in the composition, the physicochemical characterization of the graphene is performed after calcination of the graphene for 12 minutes at 600° C. in a closed crucible placed in a muffle furnace or after dissolution of the matrix and filtration of the graphenes. Dissolution is preferably performed in meta-cresol or hexafluoroisopropanol at 25° C.

The specific surface area is measured according to the BET method as described in the standard ISO 9277:2010.

The term “polar graphene” means graphene comprising more than just carbon atoms, i.e. graphene comprising carbon atoms and other atoms, for instance heteroatoms such as O, N, F, etc.

Preferably, the polar graphene comprises oxygen atoms. Preferably, the polar graphene according to the invention has a carbon atom content, relative to the total number of graphene atoms (excluding any hydrogen atoms present in the graphene), of less than or equal to 99.9%, preferably between 55% and 99.5%, advantageously between 65% and 98%, more preferentially between 75% and 95%, even more preferably between 90% and 99.5%.

Preferably, the polar graphene according to the invention has a heteroatom (for example O, N, F, etc.) content of between 0.1% and 45%.

Preferably, the polar graphene according to the invention has an oxygen atom content relative to the total number of graphene atoms (excluding any hydrogen atoms present in the graphene) of between 0.1% and 45%, preferably between 5% and 35%, more preferably between 0.5% and 10%.

Preferably, the polar graphene according to the invention has a nitrogen atom content relative to the total number of graphene atoms (excluding any hydrogen atoms present in the graphene) of between 0.1% and 5%, preferably between 0.1% and 2%, more preferably between 0.5% and 2%.

Determination of the ratios between the various atoms present in the graphene may be performed by elemental analysis. This method is described in the scientific article by Jianguo Song, Xinzhi Wang and Chang-Tang Chang: “Preparation and Characterization of Graphene Oxide”, Journal of Nanomaterials, Vol. 2014, Article ID 276143, 6 pages, 2014″.

The specific surface area according to the BET method is between 20 and 1000 m²/g, preferably between 50 and 750 m²/g.

The polar graphene may notably be an oxidized graphene (graphene oxide) or a graphene comprising at least one polyamide-reactive function, notably at least one function chosen from maleic anhydrides, carboxylic acids, primary amines and isocyanates, preferably maleic anhydrides and amines.

The polar graphene may also be a reduced graphene oxide. This type of graphene is obtained by reduction of graphene oxide, resulting in a decrease in the oxygen content in the graphene. This reduction step may, for example, be performed thermally (exposure to heat), chemically (in the presence of a reducing agent such as sodium borohydride NaBH₄, hydroiodic acid HI, hydrazine N₂H₄) and/or photochemically (exposure to radiation in the presence of a photocatalyst).

In one embodiment, the polar graphene comprises one or more functions chosen from alcohol functions, ketone functions, carboxylic acid functions and epoxide functions. Preferably, the polar graphene comprises at least two and advantageously at least three different functions chosen from alcohol functions, ketone functions, carboxylic acid functions and epoxide functions. The polar graphene preferably has an average thickness of between 0.5 and 100 nm, preferably between 1 and 100 nm, more preferably between 0.5 and 75 nm, more preferably between 1 and 50 nm, more preferably between 1.5 and 50 nm, more preferentially between 2 and 25 nm.

The polar graphene has lateral dimensions of between 0.1 and 100 μm, notably between 0.25 and 75 μm, advantageously between 0.4 and 50 μm, preferably between 0.5 and 40 μm, more preferably between 0.5 and 10 μm.

The number of graphene layers may be determined by means of X-ray diffraction or atomic force microscopy. Raman spectroscopy is preferred for graphene materials having few layers. The graphene's thickness and dimensions can also be determined by means of optical, scanning electron or transmission electron microscopy. Methods for measuring the average thickness and lateral dimensions of graphene are described in the standard ISO/TS 21356-1:2021.

Advantageously, the graphene and polyamide are covalently bonded via an amide, ester, urea or urethane function, preferably an amide function.

Preferably, the composition according to the invention comprises less than 10% by weight, preferably less than 1% by weight, and preferentially less than 0.1% by weight of carbon nanotubes, relative to the total weight of the composition.

In one embodiment, the composition according to the invention is free of carbon nanotubes.

### Impact Modifier

The impact modifier can be present at up to 40% by weight, relative to the total weight of the composition.

In one embodiment, the impact modifier is present at up to 35% by weight relative to the total weight of the composition, in particular up to 30% by weight relative to the total weight of the composition, preferably up to 15% by weight, more preferably up to 12% by weight relative to the total weight of the composition.

In another embodiment, the impact modifier is present at from 3% to 40% by weight relative to the total weight of the composition, in particular from 3% to 35%, in particular from 3% to 30% by weight, preferably from 3% to 15% by weight, for example from 3% to 12% by weight, relative to the total weight of the composition.

The impact modifier advantageously consists of a polymer with a flexural modulus of less than 100 MPa measured according to the standard ISO 178:2010, determined at 23° C. with a relative humidity: RH of 50%, and a Tg of less than 0° C. (measured according to the standard 11357-2:2013 at the inflection point of the DSC thermogram, at a heating rate of 20 K/min), in particular a polyolefin.

In one embodiment, polyether block amides (PEBA) are excluded from the definition of the impact modifiers.

The polyolefin of the impact modifier may be functionalized or non-functionalized or be a mixture of at least one which is functionalized and/or of at least one which is non-functionalized. To simplify, the polyolefin has been denoted (B) and functionalized polyolefins (B1) and non-functionalized polyolefins (B2) have been described below.

A nonfunctionalized polyolefin (B2) is conventionally a homopolymer or copolymer of alpha-olefins or of diolefins, for instance ethylene, propylene, 1-butene, 1-octene or butadiene. Examples that may be mentioned include:
polyethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/alpha-olefin such as ethylene/propylene, EPR (abbreviation for ethylene-propylene-rubber) and ethylene/propylene/diene (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

The functionalized polyolefin (B1) may be a polymer of alpha-olefins having reactive units (the functionalities); such reactive units are acid, anhydride or epoxy functions. By way of example, mention may be made of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, etc.), or else with carboxylic acid anhydrides, such as maleic anhydride. A functionalized polyolefin is, for example, a PE/EPR blend with a weight ratio which can vary within broad limits, for example between 40/60 and 90/10, said blend being cografted with an anhydride, especially maleic anhydride, with a degree of grafting of, for example, from 0.01% to 5% by weight.

The functionalized polyolefin (B1) may be chosen from the following (co) polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin, such as ethylene/propylene, copolymers, EPRs (abbreviation for ethylene propylene rubber) and ethylene/propylene/diene (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) may also be chosen from ethylene/propylene copolymers, predominant in propylene, grafted with maleic anhydride and then condensed with monoamino polyamide (or polyamide oligomer) (products described in EP-A-0342066).

The functionalized polyolefin (B1) may also be a copolymer or terpolymer of at least the following units: (1) ethylene, (2)alkyl (meth)acrylate or saturated carboxylic acid vinyl ester and (3) anhydride such as maleic anhydride, or (meth)acrylic acid, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1-C8 alkyl methacrylates and acrylates and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) may also be crosslinked via any suitable process or agent (diepoxy, diacid, peroxide, etc.); the term “functionalized polyolefin” also includes mixtures of the abovementioned polyolefins with a difunctional reagent such as diacid, dianhydride, diepoxy, etc. that is capable of reacting with these polyolefins, or mixtures of at least two functionalized polyolefins that can react with each other.

The abovementioned copolymers, (B1) and (B2), may be copolymerized in random or block fashion and may have a linear or branched structure.

The molecular weight, the MFI index and the density of these polyolefins may also vary within a broad range, as those skilled in the art will appreciate. MFI is the abbreviation for the Melt Flow Index. It is measured according to the standard ASTM 1238.

Advantageously, the nonfunctionalized polyolefins (B2) are chosen from polypropylene homopolymers or copolymers and any ethylene homopolymer or copolymer of ethylene and of a comonomer of higher alpha-olefin type, such as butene, hexene, octene, or 4-methyl-1-pentene. Mention may be made, for example, of PPs, high density PES, medium density PEs, linear low density PEs, low density PEs or very low density PEs. These polyethylenes are known to those skilled in the art as being produced according to a “radical” process, according to a “Ziegler” type catalysis or, more recently, according to a “metallocene” catalysis.

Advantageously, the functionalized polyolefins (B1) are chosen from any polymer comprising α-olefin units and units carrying reactive polar functions, such as epoxy, carboxylic acid or carboxylic acid anhydride functions. Examples of such polymers that may be mentioned include terpolymers of ethylene, of alkyl acrylate and of maleic anhydride or of glycidyl methacrylate, such as the Lotader® products (SK Functional Polymers), or polyolefins grafted with maleic anhydride, such as the Orevac® products (SK Functional Polymers), and also terpolymers of ethylene, of alkyl acrylate and of (meth)acrylic acid. Mention may also be made of polypropylene homopolymers or copolymers grafted with a carboxylic acid anhydride and then condensed with polyamides or monoamino polyamide oligomers.

Preferably, the impact modifier of the invention, which is preferably a polyolefin as described above, has a carbon atomic content of more than 70%, preferably more than 80%, more preferentially more than 90%, relative to the number of atoms in the polyolefin except for the hydrogen atoms. This carbon content allows a certain polarity of the impact modifier to be determined. The carbon content of the impact modifier can be measured via any technique known to those skilled in the art, notably elemental analysis.

Preferably, the impact modifier is chosen from olefin copolymers and notably copolymers comprising ethylene or propylene units.

### Additive

The composition according to the invention may also comprise at least one additive. The additive may be present at up to 5% by weight relative to the total weight of the composition. Thus, the composition according to the invention comprises from 0% to 5% by weight of additive relative to the total weight of the composition.

In one embodiment, the additive is present at from 0.1% to 5% by weight relative to the total weight of the composition of layer (I).

The additives may be chosen from an antioxidant, a polycondensation catalyst, a heat stabilizer, a UV absorber, a light stabilizer, a lubricant, a mineral filler, a flame retardant, a nucleating agent, a plasticizer, a dye, carbon black and carbon-based nanofillers.

In the context of the present invention, the term “polycondensation catalyst” means catalysts used for the preparation of polyamide.

Preferably, the composition of the invention comprises as additive at least one organic or inorganic stabilizer such as phenolic, phosphite or copper-based antioxidants.

In one embodiment, the composition of the invention may also comprise from 5% to 49% by weight, preferably from 5% to 30% by weight, relative to the total weight of the composition, of short reinforcing fibers.

The “short” fibers are between 100 and 400 μm and preferably between 200 and 400 μm in length.

These short reinforcing fibers may be chosen from:
natural fibers
mineral fibers, said fibers having high melting temperatures Tm′ above the melting temperature Tm of said semicrystalline polyamide of the invention and above the polymerization and/or processing temperature;
polymeric fibers or polymer fibers having a melting temperature Tm′, or if not Tm′, a glass transition temperature Tg′, above the polymerization temperature or above the melting temperature Tm of said semicrystalline polyamide constituting said matrix of the thermoplastic material and above the processing temperature;
or mixtures of the abovementioned fibers.

As mineral fibers that are suitable for use in the invention, mention may be made of carbon fibers, which include fibers of nanotubes or carbon nanotubes (CNTs), carbon nanofibers or graphenes; silica fibers such as glass fibers, in particular of E, R or S2 type; boron fibers; ceramic fibers, in particular silicon carbide fibers, boron carbide fibers, boron carbonitride fibers, silicon nitride fibers, boron nitride fibers, basalt fibers; fibers or filaments based on metals and/or alloys thereof; fibers of metal oxides, in particular of alumina (Al2O3); metallized fibers such as metallized glass fibers and metallized carbon fibers, or mixtures of the abovementioned fibers.

More particularly, these fibers may be chosen as follows:
the mineral fibers may be chosen from: carbon fibers, carbon nanotube fibers, glass fibers, in particular of E, R or S2 type; boron fibers, ceramic fibers, in particular silicon carbide fibers, boron carbide fibers, boron carbonitride fibers, silicon nitride fibers, boron nitride fibers, basalt fibers, fibers or filaments based on metals and/or alloys thereof, fibers based on metal oxides such as Al2O3, metallized fibers such as metallized glass fibers and metallized carbon fibers, or mixtures of the abovementioned fibers, and
the polymer fibers or polymeric fibers, under the abovementioned condition, are chosen from:
thermosetting polymer fibers and more particularly those chosen from: unsaturated polyesters, epoxy resins, vinyl esters, phenolic resins, polyurethanes, cyanoacrylates and polyimides, such as bismaleimide resins, or aminoplasts resulting from the reaction of an amine such as melamine with an aldehyde such as glyoxal or formaldehyde,
thermoplastic polymer fibers, more particularly chosen from:
polyamide fibers, in particular polyphthalamide fibers,
fibers of aramids (such as Kevlar®) and aromatic polyamides such as those corresponding to one of the formulae: PPD.T, MPD.I, PAA and PPA, with PPD and MPD being respectively p- and m-phenylenediamine, PAA being polyarylamides and PPA being polyphthalamides,
fibers of polyamide block copolymers such as polyamide/polyether, fibers of polyaryl ether ketones (PAEKs) such as polyether ether ketone (PEEK), polyether ketone ketone (PEKK) or polyether ketone ether ketone ketone (PEKEKK).

The preferred short reinforcing fibers are short fibers chosen from: carbon fibers, including those which are metallized, glass fibers, including those which are metallized, of E, R, S2 type, fibers of aramids (such as Kevlar®) or aromatic polyamides, polyaryl ether ketone (PAEK) fibers, such as polyether ether ketone (PEEK) fibers, polyether ketone ketone (PEKK) fibers, polyether ketone ether ketone ketone (PEKEKK) fibers, or mixtures thereof.

The natural fibers may be chosen from flax, castor bean, wood, sisal, kenaf, coconut, hemp and jute fibers.

Preferably, the reinforcing fibers present in the composition according to the invention are chosen from glass fibers, carbon fibers, flax fibers and mixtures thereof, and more preferentially glass fibers and carbon fibers, and even more preferentially glass fibers.

Preferably, the composition of the invention does not comprise any continuous fibers.

In a preferred embodiment, the composition of the invention does not comprise any long reinforcing fibers, i.e. reinforcing fibers longer than 400 μm.

### Plasticizer

The composition according to the invention may also comprise at least one plasticizer. The plasticizer content in the composition according to the invention is from 0% to 14% by weight relative to the total weight of the composition.

By way of example, the plasticizers are chosen from benzenesulfonamide derivatives, such as n-butylbenzenesulfonamide (BBSA); ethyltoluenesulfonamide or N-cyclohexyltoluenesulfonamide; hydroxybenzoic acid esters such as 2-ethylhexyl para-hydroxybenzoate and 2-hexyldecyl para-hydroxybenzoate; tetrahydrofurfuryl alcohol esters or ethers such as oligoethyleneoxytetrahydrofurfuryl alcohol; and esters of citric acid or of hydroxymalonic acid, such as oligoethyleneoxy malonate.

It would not constitute a departure from the scope of the invention to use a mixture of plasticizers.

In one embodiment, the plasticizer is present in the composition at from 1% to 14% by weight, in particular from 1% to 12% by weight, relative to the total weight of the composition.

In another embodiment, the plasticizer is present at from 5% to 14% by weight, in particular from 5% to 12% by weight, relative to the total weight of the composition.

In a particularly preferred embodiment, the composition comprises, relative to the total weight of the composition, less than 1% by weight of plasticizer, preferably less than 0.5% by weight of plasticizer.

In a particularly preferred embodiment, the composition of the invention does not comprise any plasticizer.

Particularly preferably, the present invention relates to a composition comprising, relative to the total weight of the composition:
at least 50% by weight of at least one polyamide with an inherent viscosity of greater than 1.2;
from 0.05% to 20% by weight of a polar graphene with a mean thickness of between 0.5 and 75 nm;
from 3% to 40% by weight of at least one impact modifier.

### Process for Preparing the Composition

The present invention also relates to a process for preparing a composition as described above.

In a first embodiment, the process for preparing the composition according to the invention comprises the steps of:
(i) preparing a masterbatch by dispersing graphene in a polyamide matrix; and then
(ii) mixing the masterbatch into the polyamide according to the invention comprising optional impact modifiers, additives and plasticizers.

Preferably, in step (i), the graphene content is from 10% to 50% by weight relative to the weight of the masterbatch.

Advantageously, the polyamide of the masterbatch is identical to the polyamide of the composition according to the invention.

Preferably, in step (ii), the masterbatch content is between 1% and 20% relative to the total weight of the mixture obtained in step (ii).

Preferably, in step (ii), the masterbatch and the polyamide are mixed in the melt. The mixing can take place in any device for mixing, kneading or extruding plastics in the melt known to those skilled in the art, such as an internal mixer, an open mill, an extruder, such as a single-screw extruder or a counter-rotating or co-rotating twin-screw extruder, a co-kneader, such as a continuous co-kneader, or a stirred reactor. Preferably, the mixing takes place in an extruder or a co-kneader, more preferentially in an extruder, even more preferentially in a twin-screw extruder.

Preferably, the mixing in step (ii) is performed at a temperature at least 10° C. higher than the melting temperature of the polyamide, preferably at a temperature at least 20° C. higher than the melting temperature of the polyamide, more preferably at a temperature at least 30° C. higher than the melting temperature of the polyamide.

Advantageously, the mixing is performed for a time of from 30 seconds to 15 minutes, preferably from 40 seconds to 10 minutes. Preferably, the mixing is performed with stirring.

Prior to mixing in step (ii), the masterbatch and the polyamide may independently be in the form of powder or granules.

Advantageously, the preparation process comprises a step of shaping the mixture obtained in step (ii) into the form of granules or powder. When the mixture is formed into a powder, it is preferably first formed into granules or flakes and the granules or flakes are then ground into powder. Any type of mill can be used, such as a hammer mill, a pin mill, an attrition disc mill or an impact classifier mill.

In another embodiment, the composition according to the invention can be prepared, preferably in one step, by dispersing graphene in the polyamide according to the invention in the melt, optionally in the presence of additives, impact modifiers and/or plasticizers.

In this embodiment, the preparation process comprises a step of shaping the mixture obtained into the form of granules or powder. When the mixture is formed into a powder, it is preferably first formed into granules or flakes and the granules or flakes are then ground into powder. Any type of mill can be used, such as a hammer mill, a pin mill, an attrition disc mill or an impact classifier mill.

This second embodiment relating to the process is not preferred, as it poses health risks (notably inhalation) due to the small size of the graphene particles.

Preferably, the composition according to the invention is not obtained by polymerization of polyamide in the presence of graphene. Specifically, such a process requires large amounts of solvent and is thus not preferred for environmental and economic reasons. Furthermore, the use of graphene in the polymerization reactor pollutes said reactor.

### Single-Layer or Multilayer Structure

The present invention also relates to single-layer or multilayer structures in which the layer in the case of the single-layer structure or at least one of the layers in the case of the multilayer structure is formed totally or partly from the composition according to the invention, preferably consisting of the composition according to the invention.

The structures according to the present invention are preferably intended for transporting, storing and/or distributing fluid, notably fluid for transport vehicles, notably motor vehicles and other transport vehicles such as trains, trucks, subways, etc.

The term “motor vehicle” refers to any vehicle powered by an internal combustion engine, electric or hybrid motor, equipped with wheels or caterpillar tracks, to the exclusion of a flying vehicle.

The motor vehicle may be a two-wheeled, three-wheeled, four-wheeled or caterpillar-tracked vehicle.

For example, it is chosen from an electric bicycle, a moped, a motorcycle, a side car, a car, a van, a tractor, a truck, a bus, a coach, a snowmobile, an autochenille, a bulldozer, a snow groomer and a military tank. In particular, it is chosen from a car, a van, a truck, a bus and a coach.

The single-layer or multilayer structures of the present invention may be tanks, pipes (or tubes) or liners. Throughout the description, the term “tube” or “pipe” may be used and denotes the same thing.

In one embodiment, the present invention relates to single- or multi-layer structures such as tanks, for fluid storage, comprising at least one layer obtained with the composition of the invention, preferably at least one layer of which consists of the composition according to the invention.

In another embodiment, the present invention relates to single- or multi-layer tubular (MLT) structures for fluid transport and distribution, comprising at least one layer obtained with the composition of the invention, preferably comprising at least one layer consisting of the composition of the invention.

Preferably, the multilayer structures comprise at least one other layer, preferably comprising a polyamide.

The multilayer structures according to the present invention (MLT or tank) comprise at least one layer obtained with the composition of the invention, preferably a layer consisting of the composition according to the invention, preferably this layer is the innermost layer (in contact with the fluid), and one or more other layers for example chosen from the group consisting of reinforcing layers (notably composite layers), sealing layers (barrier layers), chemical resistance layers, burst strength layers, etc. These multilayer structures are well known to those skilled in the art.

The term “fluid” denotes a gas, notably used in motor vehicles, or a liquid, notably used in the motor vehicle sector. Examples of liquids notably include oil, brake fluid, urea solution, glycol-based coolant, fuels, notably gasoline, diesel, LPG, bio-gasoline or bio-diesel, in particular gasoline and more particularly alcohol-blended gasoline. The fluid according to the invention may also be hydrogen.

In a preferred embodiment, air, nitrogen and oxygen are excluded from the definition of said fluid.

In one embodiment, said fluid denotes fuels, in particular gasoline, notably alcohol-blended gasoline.

In another embodiment, said fluid denotes hydrogen.

The term “gasoline” denotes a mixture of hydrocarbons resulting from the distillation of petroleum, to which additives or alcohols, such as methanol and ethanol, can be added, it being possible for the alcohols to be predominant components in some cases.

The expression “alcohol-blended gasoline” denotes a gasoline to which methanol or ethanol has been added. It also denotes a gasoline of E95 type, which does not contain a product from the distillation of petroleum.

In the present invention, the tank can be a tank for the mobile storage of hydrogen, that is to say on a truck for the transportation of hydrogen, on a car for the transportation of hydrogen and the supplying with hydrogen of a fuel cell, for example, on a train for supplying with hydrogen or on a drone for supplying with hydrogen, but it can also be a tank for the stationary storage of hydrogen at a station for the distribution of hydrogen to vehicles. The tank may also be a fuel or coolant storage tank.

In one embodiment, the multilayer structure according to the present invention can, for example, be a hydrogen tank and comprises or consists of several layers, notably two layers, to the exclusion of a film or granulate. Generally, hydrogen tanks comprise at least one barrier layer (or sealing layer) and one reinforcing layer. Hydrogen tanks may comprise or consist of, for example, several sealing layers and several reinforcing layers, or one sealing layer and several reinforcing layers, or several sealing layers and one reinforcing layer, or one sealing layer and one reinforcing layer.

The term “barrier layer” (or “sealing layer”) denotes a layer having features of low permeability and good resistance to the various constituents of fluids, notably fuels and hydrogen. In other words, the barrier layer slows down the passage of the fluid, notably fuel (both for its polar components (such as ethanol) and its apolar components (hydrocarbons)) or hydrogen, into the other layers of the structure or even outside the structure. The barrier layer is thus a layer which above all prevents excessive gasoline loss to the atmosphere by diffusion, thus avoiding atmospheric pollution.

Thus, the present invention preferably relates to:
a single- or multi-layer tubular structure, for transporting, distributing or storing fluid, comprising at least one layer, preferably an internal layer, formed totally or partly from the composition according to the invention, preferably comprising at least one layer, preferably an internal layer, consisting of the composition according to the invention;
a single-layer tubular structure, for transporting, distributing or storing fluid, formed totally or partly from the composition according to the invention; preferably, the single-layer tubular structure consists of the composition according to the invention;
a multilayer tubular structure for transporting, distributing or storing fluid, comprising at least one layer, preferably an inner layer, formed totally or partly from the composition according to the invention, preferably comprising at least one layer, preferably an inner layer, consisting of the composition according to the invention and at least one other layer, preferably the other layer comprises a polyamide;
a single- or multilayer tank for transporting or storing fluid, comprising at least one layer, preferably an inner layer, formed totally or partly from the composition according to the invention, preferably comprising at least one layer, preferably an inner layer, consisting of the composition according to the invention;
a single-layer tank, for transporting or storing fluid, formed totally or partly from the composition according to the invention; preferably, the single-layer tank consists of the composition according to the invention;
a multilayer tank, for transporting or storing fluid, comprising at least one layer, preferably an inner layer, formed totally or partly from the composition according to the invention, preferably comprising at least one layer, preferably an inner layer, consisting of the composition according to the invention and at least one other layer; preferably, the other layer consists of a polyamide.

In one embodiment, the structures of the present invention may be used for transporting, distributing and storing hydrogen (H₂).

In another embodiment, the structures of the present invention may be used for transporting, distributing and storing coolant.

In another embodiment, the structures of the present invention may be used for transporting, distributing and storing fuel.

The present invention also relates to a process for preparing single-layer or multi-layer structures as described above, comprising a step of manufacturing a sealing layer by injection, extrusion, extrusion-blow molding or rotational molding using the composition according to the invention.

In one embodiment, the structure is a multilayer structure and also comprises a step of filament winding of the reinforcing layer as defined above around the sealing layer as defined above.

### Use of the Composition

The present invention also relates to the use of the composition according to the invention for the manufacture of a single-layer or multilayer structure, as described above. The single-layer or multilayer structure is preferably obtained by a step of preparing the at least one layer comprising the composition according to the invention by injection, extrusion, extrusion-blowing or rotational molding using the composition of the invention. Other layers may also be present and in particular implemented simultaneously.

### Use of Graphene

The present invention also relates to the use of 0.05% to 20% by weight, preferably 0.1% to 15% by weight, more preferentially 0.1% to 5% by weight, even more preferentially 0.1% to 2% by weight, preferably 0.1% to 1.75% by weight, more preferentially 0.1% to 1.5% by weight, more preferentially 0.1% to 1% by weight, and even more preferably between 0.1% and 0.75% by weight, of at least one polar graphene with an average thickness of between 0.5 and 100 nm, preferably between 1 and 100 nm, preferably between 0.5 and 75 nm, preferably between 1 and 50 nm, preferably between 1.5 and 50 nm, more preferentially between 2 and 25 nm, in a composition comprising at least 50% by weight of at least one polyamide with an inherent viscosity of greater than 1.2, optionally up to 5% by weight of at least one additive, optionally up to 40% by weight of at least one impact modifier and/or optionally up to 14% by weight of at least one plasticizer, preferably less than 1% by weight of plasticizer, even more preferably less than 0.1% by weight of plasticizer, and, preferably, the composition is free of plasticizer, the percentages being given relative to the total weight of the composition, to obtain an extractable matter content of less than or equal to 4 g/m², preferably less than or equal to 3 g/m².

According to a preferred embodiment, the composition comprises, relative to the total weight of polyamide, more than 50% by weight, preferably more than 70% by weight and more preferentially more than 85% by weight of aliphatic polyamide. Preferably, the composition according to the invention comprises, by weight relative to the total weight of polyamide, 100% by weight of aliphatic polyamide.

The present invention also relates to the use of 0.05% to 20% by weight, preferably 0.1% to 15% by weight, more preferentially 0.1% to 5% by weight, even more preferably 0.1% to 2% by weight, preferably 0.1% to 1.75% by weight, more preferentially 0.1% to 1.5% by weight, more preferentially 0.1% to 1% by weight, and even more preferably between 0.1% and 0.75% by weight, of at least one polar graphene with an average thickness of between 0.5 and 100 nm, preferably between 1 and 100 nm, preferably between 0.5 and 75 nm, preferably between 1 and 50 nm, preferably between 1.5 and 50 nm, more preferentially between 2 and 25 nm, in a composition comprising at least 50% by weight of at least one polyamide with an inherent viscosity of greater than 1.2, optionally up to 5% by weight of at least one additive, optionally up to 40% by weight of at least one impact modifier and/or optionally up to 14% by weight of at least one plasticizer, preferably less than 1% by weight of plasticizer, even more preferably less than 0.1% by weight of plasticizer, and, preferably, the composition is free of plasticizer, the percentages being given relative to the total weight of the composition, to obtain an extractable matter content less than that obtained for the same graphene-free composition. In the context of the present invention, the term “same graphene-free composition” means a comparative composition in which graphene has been replaced with the same amount of polyamide, all other things being equal. It should be understood that when the composition according to the invention comprises a polyamide mixture, then the polyamide which replaces the graphene in the comparative composition is the same polyamide mixture as that in the composition according to the invention in the same relative proportions.

Preferably, the composition comprises, relative to the total weight of polyamide, more than 50% by weight, preferably more than 70% by weight and more preferentially more than 85% by weight of aliphatic polyamide. Preferably, the composition according to the invention comprises, by weight relative to the total weight of polyamide, 100% by weight of aliphatic polyamide.

In one embodiment, the extractable matter content is determined by a test consisting in filling a tubular structure with FAM-B-type alcohol-blended gasoline and heating the whole at 60° C. for 96 hours, then emptying the tube by filtering it into a beaker. The beaker filtrate is then allowed to evaporate at room temperature, and the residue is weighed, thus giving the extractable matter content per unit of internal tube surface area. This measurement method is notably described in the standard TL52712.

The alcohol-blended gasoline FAM B is described in the standards DIN 51604-1:1982, DIN 51604-2:1984 and DIN 51604-3:1984. Briefly, alcohol-blended gasoline FAM A is first prepared with a mixture of 50% of toluene, 30% of isooctane, 15% of diisobutylene and 5% of ethanol then FAM B is prepared by mixing 84.5% of FAM A with 15% of methanol and 0.5% of water. FAM B consists in total of 42.3% of toluene, 25.4% of isooctane, 12.7% of diisobutylene, 4.2% of ethanol, 15% of methanol and 0.5% of water.

The term “extractable matter” is intended to denote all the compounds originating from the composition forming the layers of the single-layer or multi-layer structure and which can be carried away by the fluid. Examples of extractable matter include plasticizers, monomers, oligomers, additives, etc.

The extractable matter content is measured in accordance with the standard TL52712. Preferably, the use of the composition according to the invention allows achieving an extractable matter content of less than or equal to 4 g·m⁻², preferably 3 g·m⁻².

The present invention also relates to the use of 0.05% to 20% by weight, preferably 0.1% to 15% by weight, more preferentially 0.1% to 5% by weight, even more preferentially 0.1% to 2% by weight, preferably 0.1% to 1.75% by weight, more preferentially 0.1% to 1.5% by weight, more preferentially 0.1% to 1% by weight, and even more preferably between 0.1% and 0.75% by weight, of at least one polar graphene with an average thickness of between 0.5 and 100 nm, preferably between 1 and 100 nm, more preferably between 0.5 and 75 nm, more preferably between 1 and 50 nm, more preferably between 1.5 and 50 nm, more preferentially between 2 and 25 nm, in a composition comprising at least 50% by weight of at least one polyamide with an inherent viscosity of greater than 1.2, optionally up to 5% by weight of at least one additive, optionally up to 40% by weight of at least one impact modifier and/or optionally up to 14% by weight of at least one plasticizer, preferably less than 1% by weight of plasticizer, even more preferably less than 0.1% by weight of plasticizer, and, preferably, the composition is free of plasticizer, the percentages being given relative to the total weight of the composition, to obtain a permeability less than that obtained for the same graphene-free composition. In the context of the present invention, the term “same graphene-free composition” means a comparative composition in which graphene has been replaced with the same amount of polyamide, all other things being equal. It should be understood that when the composition according to the invention comprises a polyamide mixture, then the polyamide which replaces the graphene in the comparative composition is the same polyamide mixture as that in the composition according to the invention in the same relative proportions.

According to a preferred embodiment, the composition preferably comprises, relative to the total weight of polyamide, more than 50% by weight, preferably more than 70% by weight and more preferentially more than 85% by weight of aliphatic polyamide. Preferably, the composition according to the invention comprises, by weight relative to the total weight of polyamide, 100% by weight of aliphatic polyamide.

The permeability according to the invention is the permeability of the single-layer or multilayer structure to the fluid.

In a particular embodiment, the measured permeability is the hydrogen permeability and is measured according to the standard ISO 15105-2 at atmospheric pressure and at 60° C. Preferably, the hydrogen permeability measured according to the standard ISO 15105-2 at atmospheric pressure and at 60° C. is less than 10.00×10⁻¹⁶ mol·m/m²·s·Pa, preferably less than 9.50×10⁻¹⁶ mol·m/m²·s·Pa.

The definitions and contents of polyamide, graphene, impact modifier, plasticizer and additive mentioned above also apply.

The single-layer or multilayer structures of the invention thus have good permeability, notably permeability to hydrogen, and a low extractable matter content.

### Recyclable

In a particularly advantageous manner, the structures obtained with the composition of the invention are recyclable.

The term “recyclable” means that said single- or multilayer structure, after use and thus after transporting, distributing or storing fluids, can be reused, in particular after shredding, i.e. used in a process for manufacturing a part, in particular a new single-layer or multilayer structure, in particular by extrusion, while obtaining good mechanical properties, notably cold impact strength, high burst strength, and high elongation at break, unlike the recycling of a graphene-free structure. In the context of the present invention, the term “same graphene-free composition” means a comparative composition in which graphene has been replaced with the same amount of polyamide, all other things being equal. It should be understood that when the composition according to the invention comprises a polyamide mixture, then the polyamide which replaces the graphene in the comparative composition is the same polyamide mixture as that in the composition according to the invention in the same relative proportions.

Grinding is performed according to conventional techniques used by those skilled in the art, to a size ranging from 1 mm to 2 cm.

Said reuse of said used tubular structure may or may not be performed in admixture with virgin material.

### Examples

Unless otherwise mentioned, the percentages are expressed on a weight basis relative to the total weight of the composition.

The compositions described in Table 1 were prepared by compounding under the following conditions: The compositions were manufactured using a ZSK 40 mm twin-screw extruder (Coperion). The barrel temperature was set at 280° C. and the screw speed was 300 rpm with a flow rate of 60 kg/h. All materials were placed in the main hopper at the start of the screw.

The PA11 used is a phosphoric acid-catalyzed polyamide 11 having an acid chain end concentration of 30 μeq/g and an amine chain end concentration of 33 μeq/g.

The PPA used is a PPA MXD10 having an acid chain end concentration of 72 ueq/g and an amine chain end concentration of 17 μeq/g.

The impact modifier is Tafmer MH5020C, sold by the company Mitsui Chemicals.

Graphene 1 is an apolar graphene with an average thickness of 2 nm and average lateral dimensions of 980 nm. Graphene 1 is not a graphene oxide.

Graphene 2 is a polar graphene consisting of 99 mol % carbon atoms and having an average thickness of 102 nm and average lateral dimensions of 1050 nm.

Graphene 3 is a reduced graphene oxide comprising 6 mol % oxygen atoms relative to the carbon atoms, and having an average thickness of 1.6 nm and average lateral dimensions of 2300 nm.

Graphene 4 is a graphene comprising 1 mol % nitrogen atoms relative to carbon atoms, with an average thickness of 1 nm and average lateral dimensions of 4300 nm.

The graphenes were added in the form of a masterbatch comprising 10% by weight of graphene and 90% polyamide (PA 11 or PPA).

The organic stabilizer used is a mixture consisting of 80% Irganox® 1010 and 20% Irgafos® 168 from the company BASF.

TABLE 1

| | | Example 1 | Example 2 | | Example 3 |
|---|---|---|---|---|---|
| | | according to | according | | according |
| | Comparative | the | to the | Comparative | to the |
| | Example 1 | invention | invention | Example 2 | invention |
| PA 11 (weight %) | 93.5 | 93.5 | 93.5 | 93.5 | |
| PPA (weight %) | | | | | 93.5 |
| Impact modifier (weight %) | 5 | 5 | 5 | 5 | 5 |
| Graphene 1 (weight %) | 0.5 | | | | 0.5 |
| Graphene 2 (weight %) | | | | 0.5 | |
| Graphene 3 (weight %) | | 0.5 | | | |
| Graphene 4 (weight %) | | | 0.5 | | |
| Organic stabilizer (weight %) | 1 | 1 | 1 | 1 | 1 |
| Total | 100 | 100 | 100 | 100 | 100 |

Liners with a thickness of 2 mm of the comparative compositions and of the invention were prepared by blow molding, and the hydrogen permeability measured according to the standard ISO 15105-2 at atmospheric pressure and at 60° C. was tested on plates measuring 100*100*2 mm cut from the prepared liners.

This test consists in sweeping the upper face of the film with the test gas (hydrogen) and in measuring, by gas chromatography, the flow which diffuses through the film in the lower part, swept by the carrier gas: nitrogen. The measurement is performed according to the standard ISO 15105-2.

The experimental conditions are presented in Table 2 below.

TABLE 2

| | |
|---|---|
| Apparatus | Lyssy GPM 500/GC Coupling |
| Detection | Chromatographic (TCD) |
| Column | Poraplot Q (L = 27.5 m, Dint = 0.530 |
| | mm, film thickness = 20 μ) |
| Carrier gas | nitrogen |
| Diffusing gas | Hydrogen U (H₂) |
| Test surface area | 50 cm² |
| Calibration | Absolute by direct injection |
| | through a septum |
| Column top pressure | 18 psi |
| Oven temperature | Isothermal 30° C. |
| Detector temperature | 200° C. detector: TCD [−] |
| Injector temperature | Lyssy injection loop temperature |
| Temperature/Relative | 60° C./0% RH |
| humidity | |

1A test specimens (according to the standard ISO 527) and impact bars (according to the standard ISO179) were manufactured by injection molding with the aid of a Battenfeld BA800 CDC press using unpolished molds. The following parameters were applied during the injection molding for the compositions comprising PA 11:
Barrel temperature: 250° C.
Nozzle temperature: 270° C.
Mold temperature: 40° C.
Cycle time: 60 s

The following parameters were applied during the injection molding for the compositions comprising MXD10 (Comparative Example 3):
Barrel temperature: 300° C.
Nozzle temperature: 320° C.
Mold temperature: 60° C.
Cycle time: 60 s

The elongation at break is measured at 23° C. on 1A test specimens according to the standard ISO 527. The impact resistance at 23° C. was measured according to the standard ISO 179 1eA. The elongation at break and impact strength were measured after conditioning for 15 days at 23° C. and 50% relative humidity.

The results are given in Table 3.

TABLE 3

| | | Example 1 | Example 2 | | Example 3 |
|---|---|---|---|---|---|
| | | according | according | | according |
| | Comparative | to the | to the | Comparative | to the |
| | Example 1 | invention | invention | Example 2 | invention |
| Hydrogen permeability | 10.46 | 9.20 | 8.80 | 12.54 | <8.36 |
| measured according to the | | | | | |
| standard ISO 15105-2 at | | | | | |
| atmospheric pressure and at | | | | | |
| 60° C. | | | | | |
| (10-16 mol · m/m2 · s · Pa) | | | | | |
| Elongation at break (%) | 220 | 197 | 206 | 171 | 8 |
| Impact strength at 23° C. (kJ/m²) | 16 | 53 | 16 | ND | ND |

The compositions of the invention afford a better compromise between the hydrogen barrier properties and the mechanical properties (elongation at break and impact strength).

Example 1 of the invention affords a permeability close to that of Comparative Example 1 while at the same time significantly improving the impact strength. Example 2 according to the invention affords improved permeability while at the same time maintaining the level of the mechanical properties.

1. A composition comprising, relative to the total weight of the composition:
at least 50% by weight of at least one polyamide with an inherent viscosity of greater than 1.2;
from 0.05% to 20% by weight of a polar graphene with a mean thickness of between 0.5 and 75 nm;
from 3% to 40% by weight of at least one impact modifier.

2. The composition as claimed in claim 1, also comprising:
up to 5% by weight of at least one additive; and/or
less than 1% by weight of at least one plasticizer; and/or
from 5% to 49% by weight of short reinforcing fibers.

3. The composition as claimed in claim 1, wherein the polar graphene is a graphene oxide or a graphene functionalized with at least one polyamide-reactive function.

4. The composition as claimed in claim 1, wherein the polar graphene has an oxygen atom content of between 0.1% and 45%, relative to the total number of atoms in the graphene, excluding any hydrogen atoms present in the graphene.

5. The composition as claimed in claim 1, wherein the polyamide is:
an aliphatic polyamide derived from the polycondensation of:
at least one C6 to C18 amino acid; or
at least one C6 to C18 lactam; or
at least one C4-C36 aliphatic diamine Ca with at least one C4-C36 aliphatic diacid Cb; or
a semiaromatic polyamide of formula A/XT in which A is chosen from a unit obtained from an amino acid, a unit obtained from a lactam and a unit corresponding to the formula (Cc diamine)·(Cd diacid), with c representing the number of carbon atoms of the diamine and d representing the number of carbon atoms of the diacid, c and d each being of between 4 and 36, the (Cc diamine) unit being chosen from linear or branched aliphatic diamines as defined above, cycloaliphatic diamines and alkylaromatic diamines and the (Cd diacid) unit being chosen from linear or branched aliphatic diacids, cycloaliphatic diacids and aromatic diacids; X·T denotes a unit obtained from the polycondensation of a Cx diamine and of terephthalic acid, with x representing the number of carbon atoms of the Cx diamine, x being between 5 and 36, and T corresponds to terephthalic acid.

6. The composition as claimed in claim 1, wherein the polyamide is:
an aliphatic polyamide chosen from PA6, PA66, PA11, PA12, PA610, PA612, PA1010, PA1012 and PA1212;
a semiaromatic polyamide chosen from PA MPMDT/6T, PA11/10T, PA 5T/10T, PA 11/BACT, PA 11/6T/10T, PA MXDT/10T, PA MPMDT/10T, PA BACT/10T, PA BACT/6T, PA BACT/10T/6T, PA 11/BACT/6T, PA 11/MPMDT/6T, PA 11/MPMDT/10T, PA 11/BACT/10T, PA 11/MXDT/10T and 11/5T/10T, T corresponds to terephthalic acid, MXD corresponds to m-xylylenediamine, MPMD corresponds to methylpentamethylenediamine and BAC corresponds to bis(aminomethyl)cyclohexane.

7. The composition as claimed in claim 1, comprising, relative to the total weight of polyamide:
at least 50% by weight of aliphatic polyamide.

8. The composition as claimed in claim 1, wherein the graphene content is between 0.1% and 1.75% by weight, relative to the total weight of the composition.

9. The composition as claimed in claim 1, wherein the impact modifier is chosen from olefin copolymers.

10. A single-layer or multilayer structure in which the layer in the case of the single-layer structure or at least one of the layers in the case of the multilayer structure is formed totally or partly from the composition as defined in claim 1.

11. The structure as claimed in claim 10, wherein the structure is a tubular structure.

12. The structure as claimed in claim 10, wherein the structure is a tank.

13. A method comprising using the structure as claimed in claim 10, for transporting, distributing and storing a fluid.

14. The method as claimed in claim 13, wherein the fluid is hydrogen.

15. The method as claimed in claim 13, wherein the fluid is a coolant.

16. The method as claimed in claim 13, wherein the fluid is a fuel.

17. A method comprising using a composition as claimed in claim 1, for the manufacture of a single-layer or multilayer structure by injection, extrusion, extrusion-blow molding or rotational molding.

18. A method comprising using from 0.05% to 20% by weight of at least one polar graphene with an average thickness of between 0.5 and 75 nm in a composition comprising at least 50% by weight of at least one polyamide with an inherent viscosity of greater than 1.2, optionally up to 5% by weight of at least one additive, optionally up to 40% by weight of at least one impact modifier and/or less than 1% by weight of at least one plasticizer, the percentages being given relative to the total weight of the composition, to obtain an extractable matter content of less than or equal to 4 g/m².

19. A method comprising using from 0.05% to 20% by weight of at least one polar graphene with an average thickness of between 0.5 and 75 nm in a composition comprising at least 50% by weight of at least one polyamide with an inherent viscosity of greater than 1.2, optionally up to 5% by weight of at least one additive, optionally up to 40% by weight of at least one impact modifier and/or less than 1% by weight of at least one plasticizer, the percentages being given relative to the total weight of the composition, to obtain an extractable matter content lower than that obtained for the same graphene-free composition in which graphene has been replaced with the same amount of polyamide.

20. A method comprising using from 0.05% to 20% by weight of at least one polar graphene with an average thickness of between 0.5 and 75 nm in a composition comprising at least 50% by weight of at least one polyamide with an inherent viscosity of greater than 1.2, optionally up to 5% by weight of at least one additive, optionally up to 40% by weight of at least one impact modifier and/or optionally less than 1% by weight of at least one plasticizer, the percentages being given relative to the total weight of the composition, to obtain a permeability lower than that obtained for the same graphene-free composition in which graphene has been replaced with the same amount of polyamide.

21. A process for manufacturing a single-layer or multilayer structure as defined in claim 10, wherein the method comprises a step of manufacturing a sealing layer by injection molding, extrusion, extrusion-blow molding or rotational molding.
